(19) United States
(12) Patent Application Publication
(10) Pub. No.: US 2013/0337255 A1
(43) Pub. Date: Dec. 19, 2013

(54) MELAMINE RESIN FOAM WITH PARTICULATE FILLING MATERIAL

(71) Applicants: Tobias Heinz Steinke, Speyer (DE); Tatiana Ulanova, Ludwigshafen (DE); Klaus Hahn, Kirchheim (DE); Horst Baumgartl, Ludwigshafen (DE); Christof Möck, Mannheim (DE); Bernhard Vath, Mannheim (DE); Peter Nessel, Ludwigshafen (DE); Jens-Uwe Schierholz, Bensheim (DE); Bettina Wester, Maxdorf (DE); Hans-Jürgen Quadbeck-Seeger, Bad Durkheim (DE); Dave Pung, Loveland, OH (US)

(72) Inventors: Tobias Heinz Steinke, Speyer (DE); Tatiana Ulanova, Ludwigshafen (DE); Klaus Hahn, Kirchheim (DE); Horst Baumgartl, Ludwigshafen (DE); Christof Möck, Mannheim (DE); Bernhard Vath, Mannheim (DE); Peter Nessel, Ludwigshafen (DE); Jens-Uwe Schierholz, Bensheim (DE); Bettina Wester, Maxdorf (DE); Hans-Jürgen Quadbeck-Seeger, Bad Durkheim (DE); Dave Pung, Loveland, OH (US)

(73) Assignee: BASF SE, Ludwigshafen (DE)

(21) Appl. No.: 14/001,206

(22) PCT Filed: Feb. 20, 2012
(86) PCT No.: PCT/EP2012/052835

§ 371 Date: Aug. 23, 2013

(30) Foreign Application Priority Data
Feb. 24, 2011 (EP) 11155750.0

(51) Int. Cl. C08K 3/36; C08K 7/20

(52) U.S. Cl. CPC C08K 3/36; C08K 7/20
USPC 428/221; 252/62

(57) ABSTRACT

Melamine/formaldehyde foams comprising from 0.01% to 45% by weight of a particulate filling material having an average particle diameter in the range from 5 μm to 3 mm, wherein the % by weight are based on the total weight of filling material plus melamine-formaldehyde precondensate used for foam production.

The present invention concerns melamine resin foams, processes for their production and their use.

EP-A-1 146 070 and WO-A-2007/23118 disclose impregnating with an ammonium salt and with sodium silicate, respectively, to improve the fire characteristics of melamine-formaldehyde foams. These leave something to be desired in their mechanical properties, however.

DE-A-10 2007 009127 discloses fiber-reinforced foams based on melamine-formaldehyde resins having a fiber content of 0.5% to 50% by weight. The fibrous filler used comprises short or long fibers of glass, carbon or melamine resin, and the length:diameter ratio of the fibers is preferably in the range from 5:1 to 500:1.

WO-A-2009/021963 discloses a process for producing an abrasive foam on the basis of a melamine-formaldehyde condensation product comprising 0.01% to 50% by weight of inorganic nanoparticles based on the weight of the precondensate. The inorganic nanoparticles have an average particle size of less than 1000 nm and preferably of less than 100 nm.

In general, foams based on a melamine-formaldehyde condensation product are observed to suffer an unwelcome deterioration in their mechanical properties as the proportion of fibers or particles, which may be used to achieve certain effects such as improved fire characteristics or optical effects—coloration for example, increases.

The present invention has for its object to remedy the aforementioned disadvantages and more particularly to provide filled melamine resin foams that substantially retain the good mechanical properties of the unfilled foams.

We have found that this object is achieved by novel melamine-formaldehyde foams comprising from 0.01% to 45% by weight of a particulate filling material having an average particle diameter in the range from 5 μm to 3 mm, wherein the % by weight are based on the total weight of filling material plus melamine-formaldehyde precondensate used for foam production.

The melamine-formaldehyde foams of the present invention comprise from 0.01% to 45% by weight, preferably from 1% to 30% by weight and more preferably from 5% to 20% by weight of one or more, i.e., 1 to 10, preferably 1 to 5, more preferably 1 to 3, even more preferably 1 or 2 and most preferably 1 particulate filling materials, wherein the % by weight are all based on the total weight of particulate filling material plus melamine-formaldehyde precondensate used for foam production.

According to the present invention, the particulate filling materials have an average particle diameter in the range from 5 μm to 3 mm, preferably in the range from 10 to 1000 μm and more preferably in the range from 100 to 600 μm (d₅₀ value, number averaged, determined via optical or electron microscopy combined with image analysis). The particle size distribution of the particulate filling materials can be mono-, bi- or multimodal.

The individual particles of the particulate filling materials can themselves be constructed of smaller agglomerated particles, often referred to as primary particles. For example, the particulate filling materials can be used in the form of agglomerate particles having the above-described particle diameters, in which case each agglomerate consists of smaller primary particles. Such particles in agglomerate form are known in principle to a person skilled in the art and are described in the literature; they are obtainable for example by adding agglomerization auxiliaries to the primary particles and subsequent mixing.

According to the present invention, the filling materials are present in particle form, preferably the ratio of the longest axis to the shortest axis of the particles is in the range from 4:1 to 1:1, and spherical filling materials are particularly preferred.

Useful particulate filling materials include in principle any substance, while preference is given to inorganic substances or organic polymers known to a person skilled in the art and described in the literature.

Useful inorganic particulate filling materials are preferably quartz, olivine, basalt, glass spheres, ceramic spheres, clay minerals such as for example kaolin, ammonium phosphate and phosphoric acid, sulfates such as ammonium sulfate, barium sulfate and calcium sulfate, carbonates such as calcium carbonate, and dolomite CaMg(CO₃)₂, kieselguhr, hydroxides such as aluminum, calcium hydroxide and magnesium hydroxide, zinc borates, antimony trioxide and antimony pentoxide, silicates, such as aluminum silicate and calcium silicate, such as wollastonite CaSiO₃, silimanite Al₂SiO₅, nepheline (Na,K)AlSiO₄, andalusite Al₂[O|SiO₄], feldspar (Ba,Ca,Na,K,NH₄)(Al,B,Si)₄O₈, sheet-silicates, such as montmorillonite (smectite) (Al,Mg,Fe)₂[(OH)₂|(Si,Al)₄O₁₀] Na_{0.33}(H₂O)₄, vermiculite Mg₂(Al,Fe,Mg)[(OH)₂|(Si,Al)₄O₁₀].Mg_{0.35}(H₂O)₄, allophane Al₂[SiO₅]₆O₃.n H₂O, kaolinite Al₄[(OH)₈|Si₄O₁₀], halloysite Al_{4[(OH)}₈|Si₄O₁₀].2 H₂O, mullite Al₈[(O,OH,F)|(Si,Al)O₄]₄, talcum Mg₃Si₄O₁₀(OH)₂, hydrous sulfates Ca[SO₄].2 H₂O, mica, for example muskovite, colloidal silica or mixtures thereof, preferably granular minerals, such as sands and glass spheres.

Useful particulate organic polymers are preferably polyurethane, melamine-formaldehyde resin, epoxy resin, polyester, polycarbonate, polyacrylates, polyamides or mixtures thereof.

The particulate filling materials can be used coated or uncoated. The amount of the coating material can be varied within wide limits and is generally in the range from 1% to 20% by weight, preferably in the range from 1 to 10% by weight and more preferably in the range from 1% to 5% by weight based on the particulate filling material, advantageously the amount of coating material used is the minimum sufficient to ensure coating.

Useful coating materials include polymeric entities for example melamine-formaldehyde resins. Suitable polyurethane resins, polyester resins or epoxy resins for coating are known to a person skilled in the art. Such resins may be found for example in Encyclopedia of Polymer Science and Technology (Wiley) under the following chapter headings: a) Polyesters, unsaturated: Edition 3, Vol. 11, 2004, pp. 41-64; b) Polyurethanes: Edition 3, Vol. 4. 2003, pp. 26-72 and c) Epoxy resins: Edition 3, Vol. 9, 2004, pp. 678-804. Furthermore, Ullmann's Encyclopedia of Industrial Chemistry (Wiley) contains the following chapters: a) Polyester resins, unsaturated: Edition 6, Vol. 28, 2003, pp. 65-74; b) Polyurethanes: Edition 6, Vol. 28, 2003, pp. 667-722 and c) Epoxy resins: Edition 6, Vol. 12, 2003, pp. 285-303. Furthermore, amino- or hydroxy-functionalized polymers, more particularly a polyvinylamine or polyvinyl alcohol can be used. It is similarly possible to use inorganic coating materials based on phosphate, silicate and borate groups or combinations thereof.

The particulate filling materials may also display chemical functionalizations at their surface to improve attachment to the foam structure. The chemical functionalization of the surfaces of filling materials is known in principle to a person skilled in the art and is described in WO2005/103107 for example.

The melamine-formaldehyde foams of the present invention comprise an open-cell scaffolding of foamed material, the scaffolding comprising a multiplicity of interconnected, three-dimensionally branched struts, and in each of which the particulate fillers are embedded into the pore structure. The particle size preferably corresponds to the average pore diameter of the foam structure, this average pore diameter being preferably in the range from 10 to 1000 μm and more particularly in the range from 50 to 600 μm (d₅₀ value, number averaged, determined via optical or electronic microscopy combined with image analysis). The particulate fillers can thus be ideally bound into the pore structure of the open-cell foam and immobilized from all sides of the pore scaffolding. Such a structure cannot be produced by subsequent impregnation of the foamed material with filling materials, since for this the particle size of the fillers always has to be chosen such that the particle size is smaller than the pore size of the foamed material in order that distribution in the entire foamed material may be ensured.

The melamine-formaldehyde precondensates used for producing the melamine-formaldehyde foams of the present invention generally have a molar ratio of formaldehyde to melamine in the range from 5:1 to 1.3:1 and preferably in the range from 3.5:1 to 1.5:1.

These melamine-formaldehyde condensation products, in addition to melamine, may comprise from 0% to 50% by weight, preferably from 0% to 40% by weight, more preferably from 0% to 30% by weight and more particularly from 0% to 20% by weight of other thermoset-formers and, in addition to formaldehyde, from 0% to 50% by weight, preferably from 0% to 40% by weight, more preferably from 0% to 30% by weight and more particularly from 0% to 20% by weight of other aldehydes, in cocondensed form. Preference is given to unmodified melamine-formaldehyde precondensates.

Useful thermoset-formers include for example alkyl- and aryl-substituted melamine, urea, urethanes, carboxamides, dicyandiamide, guanidine, sulfurylamide, sulfonamides, aliphatic amines, glycols, phenol or their derivatives.

Useful aldehydes include for example acetaldehyde, trimethylolacetaldehyde, acrolein, benzaldehyde, furfural, glyoxal, glutaraldehyde, phthalaldehyde, terephthalaldehyde or their mixtures. Further details concerning melamine-formaldehyde condensation products are found in Houben-Weyl, Methoden der organischen Chemie, volume 14/2, 1963, pages 319 to 402.

The melamine-formaldehyde foams of the present invention are obtainable as follows:

The particulate filling materials can be added to the feedstocks used for foam production, i.e., the melamine, the formaldehyde, their mixtures or a melamine-formaldehyde precondensate, during the foaming operation, but are preferably added before the foaming operation.

A melamine-formaldehyde precondensate and a solvent can preferably be foamed with an acid, a dispersant, a blowing agent and inorganic filling material at temperatures above the boiling temperature of the blowing agent and subsequently dried.

In one particular embodiment, the filling materials are coated by methods known to a person skilled in the art before being added to the foaming operation. This can be accomplished for example by means of a spraying apparatus in a mixing apparatus (for example an intensive mixer from Eirich). Homogeneous wetting of the filling materials is achieved in this way. In one particular embodiment, the coating material is not allowed to fully harden in order that attachment in the foam may be increased.

As melamine-formaldehyde precondensates there may be used specially prepared precondensates of the two components, melamine and formaldehyde (see reviews: a) W. Woebcken, Kunststoffhandbuch 10. Duroplaste, Munich, Vienna 1988, b) Encyclopedia of Polymer Science and Technology, 3^{rd} edition, Vol. 1, Amino Resins, pages 340 to 370, 2003 c) Ullmann's Encyclopedia of Industrial Chemistry, 6^{th} edition, Vol. 2, Amino Resins, pages 537 to 565. Weinheim 2003) or commercially available precondensates of the two components, melamine and formaldehyde. The melamine-formaldehyde precondensates generally have a molar ratio of formaldehyde to melamine in the range from 5:1 to 1.3:1 and preferably in the range from 3.5:1 to 1.5:1.

A preferred version of the process for producing the foam of the present invention comprises the stages of
(1) producing a suspension comprising a melamine-formaldehyde precondensate of the foam to be produced, particulate fillers and optionally further added components,
(2) foaming the precondensate by heating the suspension from step (1) to a temperature above the boiling temperature of the blowing agent,
(3) drying the foam obtained from step (2).

The individual process steps and the various possible versions will now be more particularly discussed.

The melamine-formaldehyde precondensate may be prepared in the presence of alcohols, for example methanol, ethanol or butanol in order that partially or fully etherified condensates may be obtained. Forming the ether groups is a way of influencing the solubility of the melamine-formaldehyde precondensate and the mechanical properties of the fully cured material.

Anionic, cationic and nonionic surfactants and also mixtures thereof can be used as dispersant/emulsifier.

Useful anionic surfactants include for example diphenylene oxide sulfonates, alkane- and alkylbenzenesulfonates, alkylnaphthalenesulfonates, olefinsulfonates, alkyl ether sulfonates, fatty alcohol sulfates, ether sulfates, α-sulfo fatty acid esters, acylaminoalkanesulfonates, acyl isethionates, alkyl ether carboxylates, N-acylsarcosinates, alkyl and alkylether phosphates. Useful nonionic surfactants include alkylphenol polyglycol ethers, fatty alcohol polyglycol ethers, fatty acid polyglycol ethers, fatty acid alkanolamides, ethylene oxide-propylene oxide block copolymers, amine oxides, glycerol fatty acid esters, sorbitan esters and alkylpolyglycosides. Useful cationic emulsifiers include for example alkyltriammonium salts, alkylbenzyldimethylammonium salts and alkylpyridinium salts.

The dispersants/emulsifiers can be added in amounts from 0.2% to 5% by weight, based on the melamine-formaldehyde precondensate.

The dispersants/emulsifiers and/or protective colloids can in principle be added to the crude dispersion at any time, but they can also already be present in the solvent at the time the microcapsule dispersion is introduced.

In principle, the process of the present invention can use both physical and chemical blowing agents.

Depending on the choice of melamine-formaldehyde precondensate, the mixture comprises a blowing agent. The amount of blowing agent in the mixture generally depends on the desired density for the foam.

“Physical” or “chemical” blowing agents are suitable (Encyclopedia of Polymer Science and Technology, Vol. I, 3^{rd} ed., Additives, pages 203 to 218, 2003).

Useful “physical” blowing agents include for example hydrocarbons, such as pentane, hexane, halogenated, more particularly chlorinated and/or fluorinated, hydrocarbons, for example methylene chloride, chloroform, trichloroethane, chlorofluorocarbons, hydrochlorofluorocarbons (HCFCs), alcohols, for example methanol, ethanol, n-propanol or isopropanol, ethers, ketones and esters, for example methyl formate, ethyl formate, methyl acetate or ethyl acetate, in liquid form or air, nitrogen or carbon dioxide as gases.

Useful “chemical” blowing agents include for example isocyanates mixed with water, releasing carbon dioxide as active blowing agent. It is further possible to use carbonates and bicarbonates mixed with acids, in which case carbon dioxide is again produced. Also suitable are azo compounds, for example azodicarbonamide.

In a preferred embodiment of the invention, the mixture further comprises at least one blowing agent. This blowing agent is present in the mixture in an amount of 0.5% to 60% by weight, preferably 1% to 40% by weight and more preferably 1.5% to 30% by weight, based on the melamine-formaldehyde precondensate. It is preferable to add a physical blowing agent having a boiling point between 0 and 80° C.

As curatives it is possible to use acidic compounds which catalyze the further condensation of the melamine resin. The amount of these curatives is generally in the range from 0.01% to 20% by weight and preferably in the range from 0.05% to 5% by weight, all based on the precondensate. Useful acidic compounds include organic and inorganic acids, for example selected from the group consisting of hydrochloric acid, sulfuric acid, phosphoric acid, nitric acid, formic acid, acetic acid, oxalic acid, toluenesulfonic acids, amidosulfonic acids, acid anhydrides and mixtures thereof.

In a further embodiment, in addition to the melamine-formaldehyde precondensate of the foam to be produced and the filling materials, the mixture also comprises an emulsifier and also optionally a curative and optionally a blowing agent.

In a further embodiment, the mixture is free of further added substances. However, for some purposes it can be advantageous to add from 0.1% to 20% by weight, preferably from 0.1% to 10% by weight, based on the melamine-formaldehyde precondensate, of customary added substances other than the particulate filling materials, such as fibers, dyes, flame retardants, UV stabilizers, agents for reducing the toxicity of fire gases or for promoting carbonization, scents, optical brighteners or pigments. These added substances preferably form a homogeneous distribution in the foamed material.

Useful pigments include for example the common organic pigments. These pigments can be mixed with the filling materials beforehand.

The next step of the process of the present invention comprises the precondensate being foamed up generally by heating the suspension of the melamine-formaldehyde precondensate and of the particulate filling materials to obtain a foamed material comprising the particulate filling materials. To this end, the suspension is generally heated to a temperature above the boiling point of the blowing agent used and foamed in a closed mold.

The introduction of energy may preferably be effected via electromagnetic radiation, for example via high-frequency radiation at 5 to 400 kW, preferably 5 to 200 kW and more preferably 9 to 120 kW per kilogram of the mixture used in a frequency range from 0.2 to 100 GHz, preferably 0.5 to 10 GHz. Magnetrons are a useful source of dielectric radiation, and one magnetron can be used or two or more magnetrons at the same time.

The foamed materials produced are finally dried, removing residual water and blowing agent from the foam.

An aftertreatment can also be utilized to hydrophobicize the foam. This aftertreatment preferably employs hydrophobic coating agents having high thermal stability and low flammability, for example silicones, siliconates or fluorinated compounds.

The process described provides blocks/slabs of foamed material, which can be cut to size in any desired shapes.

The foam blocks or slabs can optionally be thermocompressed in a further process step. Thermocompression as such is known to a person skilled in the art and described for example in WO 2007/031944, EP-A 451 535, EP-A 111 860 and U.S. Pat. No. 6,608,118. Thermocompression often provides better fixing of the particulate filling materials to the open-cell structure of foam.

The density of the foam is generally in the range from 5 to 100 kg/m³, preferably in the range from 10 to 100 kg/m³, more preferably in the range from 15 to 85 kg/m³ and more preferably in the range from 40 to 75 kg/m³.

The foam obtainable by the process of the present invention preferably has an open-cell structure having an open-cell content, when measured to DIN ISO 4590, of more than 50% and more particularly more than 80%.

The average pore diameter is preferably in the range from 10 to 1000 μm and more particularly in the range from 50 to 600 μm.

The foam of the present invention is preferably elastic.

The foam obtainable by the process of the present invention can be used in various ways for thermal and acoustical insulation in building construction and in automobile, ship and track vehicle construction, the construction of spacecraft or in the upholstery industry, for example for thermal insulation in house building or as a sound-insulating material, for example in automobiles, airplanes, trains, ships, etc. in passenger cells or in the engine compartment or for cushioning sitting and lying surfaces and also for back and arm rests. Applications are preferably in sectors requiring high thermal stability and low flammability, for example in pore burners.

In particular applications it can be advantageous for the surface of the foams of the present invention to be laminated with a lamination known in principle to a person skilled in the art. Such lamination may be effected for example, with substantial retention of the acoustical properties, with so-called “open” systems, for example perforated plates, or else with “closed” systems, for example foils or plates of plastic, metal or wood.

The melamine-formaldehyde foams of the present invention, comprising from 0.01% to 45% by weight of a particulate filling material, can be used to keep certain effects such as improved fire characteristics or optical effects—coloration for example—without an unwelcome high deterioration in the mechanical properties being observed compared with the unfilled foams.

### EXAMPLES

### Comparative Example V-A

Preparation of a melamine-formaldehyde foam without filling materials (according to WO-A-2009/021963).

75 parts by weight of a spray-dried melamine-formaldehyde precondensate (molar ratio 1:3) were dissolved in 25 parts by weight of water, then 3% by weight of formic acid, 2% by weight of a sodium Cu/Cu-alkyl sulfate, 20% by weight of pentane, all based on the precondensate, were added, this was followed by stirring and then foaming in a polypropylene mold (for foaming) by irradiation with microwave energy. After foaming, the foam was dried for 30 minutes.

The melamine-formaldehyde foam has a density of 10 g/l and a ram pressure value of 21.1 N (all ram pressure measurements to assess the mechanical quality of the melamine resin foams were carried out as described in U.S. Pat. No. 4,666,948. A cylindrical ram having a diameter of 8 mm and a height of 10 cm was pressed into a cylindrical sample having a diameter of 11 cm and a height of 5 cm in the direction of foaming at an angle of 90° until the sample tore. The tearing force [N], hereinafter also referred to as ram pressure value, provides information as to the mechanical quality of the foamed material).

### Example 1

Preparation of a melamine-formaldehyde foam using 10% by weight of quartz sand (based on the total weight of particulate filling material plus melamine-formaldehyde precondensate used for foam production) as filling material.

75 parts by weight of a spray-dried melamine-formaldehyde precondensate (molar ratio 1:3) were dissolved in 25 parts by weight of water, 3% by weight of formic acid, 2% by weight of a sodium Cu/Cu-alkyl sulfate, 20% by weight of pentane, the % by weight each being based on the precondensate, and 8.3 parts by weight of quartz sand (particle size: 0.3 to 0.7 mm, average particle diameter 0.5 mm (d₅₀ value, number averaged, determined via optical or electron microscopy combined with image analysis)), were added, which was followed by stirring and then foaming in a polypropylene mold (for foaming) by irradiation with microwave energy. After foaming, the foam was dried for 30 minutes.

The foam has a density of 6.6 g/l and a ram pressure value of 20.8 N.

### Examples 2-6

Example 1 was repeated to produce further foams having higher contents of quartz sand.

The results are collated below in Table 1:

TABLE 1

| | Quartz sand content | Density | Ram pressure |
|---|---|---|---|
| Ex. | [% by weight]* | [g/L] | value [N] |
| V-A | 0 | 10 | 21.1 |
| 1 | 10 | 6.6 | 20.8 |
| 2 | 20 | 7.2 | 21.0 |
| 3 | 40 | 8.5 | 20.7 |
| 4 | 60 | 11 | 15.4 |
| 5 | 80 | 12.3 | 13.3 |
| 6 | 100 | 12.5 | 11.3 |

*based on the total weight of particulate filling material plus melamine-formaldehyde precondensate used for foam production.

### Example 7

Preparation of a melamine-formaldehyde foam using 10% by weight of glass beads (based on the total weight of particulate filling material plus melamine-formaldehyde precondensate used for foam production) as filling material.

75 parts by weight of a spray-dried melamine-formaldehyde precondensate (molar ratio 1:3) were dissolved in 25 parts by weight of water, 3% by weight of formic acid, 2% by weight of a sodium Cu/Cu-alkyl sulfate, 20% by weight of pentane, the % by weight each being based on the precondensate, and 8.3 parts by weight of glass beads of the type Microbeads (0.4 to 0.8 mm, Sigmund Lindner GmbH, average particle diameter 0.6 mm (d₅₀ value, number averaged, determined via optical or electron microscopy combined with image analysis)), were added, which was followed by stirring and then foaming in a polypropylene mold (for foaming) by irradiation with microwave energy. After foaming, the foam was dried for 30 minutes.

The foam has a density of 6.8 g/l and a ram pressure value of 21.0 N.

### Examples 8-12

Example 7 was repeated to produce further foams having higher contents of glass spheres.

The results are collated below in Table 2:

TABLE 2

| | Glass spheres content | Density | Ram pressure |
|---|---|---|---|
| Ex. | [% by weight]* | [g/L] | value [N] |
| V-A | 0 | 10 | 21.1 |
| 7 | 10 | 6.8 | 21.0 |
| 8 | 20 | 7.4 | 21.5 |
| 9 | 40 | 8.6 | 21.1 |
| 10 | 60 | 11.3 | 15.9 |
| 11 | 80 | 12.7 | 12.8 |
| 12 | 100 | 13.1 | 11.1 |

*based on the total weight of particulate filling material plus melamine-formaldehyde precondensate used for foam production.

The examples show that the melamine-formaldehyde foams of the present invention comprising from 0.01% to 45% by weight of a particulate filling material, substantially retain the good mechanical properties of the unfilled foams, whereas in the case of known comparatively highly filled foams the mechanical properties deteriorate abruptly.

1-10. (canceled)

11. A melamine-formaldehyde foam with open-cell foam structure comprising a pore structure, which contains a plurality of interconnected, three-dimensionally branched webs and in which at least one particulate filling material is embedded into the pore structure, wherein said melamine-formaldehyde foam comprises from 0.01% to 45% by weight of said particulate filling material and the particulate filling material comprises inorganic materials having an average particle diameter in the range from 5 μm to 3 mm, and wherein the % by weight is based on the total weight of the particulate filling material plus melamine-formaldehyde precondensate used for foam production.

12. The melamine-formaldehyde foam of claim 11 wherein said melamine-formaldehyde foam comprises from 1% to 30% by weight of the particulate filling material.

13. The melamine-formaldehyde foam of claim 11 wherein the particulate filling material has an average particle diameter in the range from 10 μm to 1000 μm.

14. The melamine-formaldehyde foam of claim 11 wherein the particulate filling material comprises quartz, olivine, basalt, glass spheres, ceramic spheres, clay minerals, sulfates, carbonates, kieselguhr, silicates, colloidal silica, or mixtures thereof.

15. The melamine-formaldehyde foam of claim 11 wherein the particulate filling materials are embedded into the pore structure and the average particle diameter corresponds to the average pore diameter of the foam structure.

16. A process for producing the melamine-formaldehyde foam of 11 comprising foaming a melamine-formaldehyde precondensate in a solvent with an acid, a dispersant, a blowing agent, and the particulate filling material at temperatures above the boiling temperature of the blowing agent and subsequently drying.

17. Thermal and acoustical insulation in building construction, automobile, ship and track vehicle construction, the construction of spacecraft, or in the upholstery industry comprising the melamine-formaldehyde foam of claim 11.
